(19) United States
(12) Patent Application Publication
(10) Pub. No.: US 2007/0089355 A1
(43) Pub. Date: Apr. 26, 2007

(54) Honey do hook

(76) Inventor: Michael Y. Burgett SR., Eustace, TX (US)

Correspondence Address: Raymond M. Galasso;Galasso & Associates LP, P.O. Box 26503, Austin, TX, 78755-0503, US

(21) Appl. No.: 11/544,500

(22) Filed: Oct. 6, 2006

Related U.S. Application Data
(60) Provisional application No. 60/724,761, filed on Oct. 7, 2005.

(51) Int. Cl. A01K 97/18

(52) U.S. Cl. 43/53.5

(57) ABSTRACT

Honey Do Hook is a hook with a handle used to remove a fishing hook from a captured fish. A user holds Honey Do Hook by the handle and inserts the hook into the fishing hook, usually located in the mouth of a fish. The user then pulls one direction with the handle and the opposite direction with the fishing line containing the fishing hook. The fish can then be flipped until it is free from the fishing hook.

### CROSS REFERENCE TO RELATED APPLICATIONS

This Non-Provisional Patent Application claims priority to U.S. Provisional Patent Application No. 60/724,761 entitled “Honey Do Hook” filed on Oct. 7, 2005.

### FIELD OF THE DISCLOSURE

The disclosures made herein relate generally to the fishing accessories industry. The invention discussed herein is in the general classification of fishing hooks detachers.

### BACKGROUND

Fishing is a popular activity enjoyed by millions of people worldwide. In addition to being a recreational activity, fishing is one of the largest food acquiring industries and has been around for centuries.

Generally, the basic items needed for fishing are a hook, a line, and a sinker. However, most anglers have a variety of fishing rods, reels, line types, hooks, floats, and artificial lures. Most of these items will be stored in the angler's tackle box.

Many fishermen simply catch and release fish for sport. Hence, they prefer not to injure the fish in any way when removing it from the hook. Other people enjoy fishing but prefer not to directly contact the fish when removing it from the hook. Unfortunately, there is no satisfactory device for removing a fishing hook from the mouth of a fish without touching the fish or injuring it.

Hence, there is a need in the art for an easy to use, affordable, transportable and durable fishing hook detacher that will allow fishermen to remove hooks from fish without directly contacting the fish.

### SUMMARY OF THE DISCLOSURE

Honey Do Hook is a hook with a handle used to remove a fishing hook from a captured fish.

The principal object of this invention is to provide a device for removing a fishing hook from a fish without contacting the fish.

Another object of this invention is to provide an affordable device for removing a fishing hook from a fish without contacting the fish.

Another object of this invention is to provide an easy to use device for removing a fishing hook from a fish without contacting the fish.

Another object of this invention is to provide a durable device for removing a fishing hook from a fish without contacting the fish.

Another object of this invention is to provide a device for removing a fishing hook from a fish that can be easily transported in a standard tackle box.

Yet another object of this invention is to provide a device that will minimize injury to a fish when removing a hook from its mouth.

### BRIEF DESCRIPTION OF THE DRAWINGS

FIG. 1 depicts a perspective view of the preferred embodiment of the invention.

FIG. 2 depicts a cross-sectional view of the preferred embodiment of the invention cut along the line A-A of FIG. 1.

### DETAILED DESCRIPTION OF THE DRAWINGS

The preferred embodiment of Honey Do Hook is comprised of a hook, an inverted triangle-shaped handle and a rod connecting the hook to the handle.

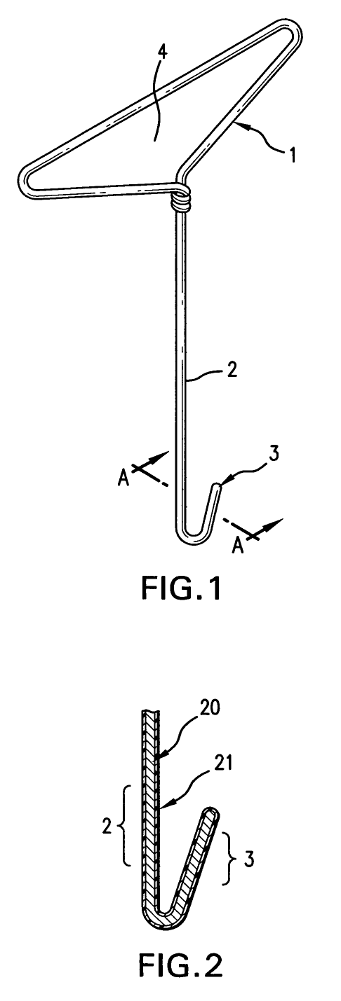

FIG. 1 depicts the preferred embodiment of the invention. A handle 1 is connected to a rod 2 having a hook 3 on the end opposite the handle 1. The handle 1 has an inverted triangle-shaped design in the preferred embodiment though a variety of styles are possible. The handle 1 of the preferred embodiment is designed to have an opening 4 in the center to permit it to be easily gripped in a user's hand. The rod 2 is approximately four inches in length and the hook 3 is approximately three-quarters of an inch in width in the preferred embodiment. The handle 1 is approximately five inches in width. The handle 1, rod 2 and hook 3 are one-eighth of an inch in diameter with a steel interior and a plastic coating in the preferred embodiment.

FIG. 2 depicts a cross-sectional view of the preferred embodiment of the invention cut along the line A-A of FIG. 1. The interior of the rod 2 and hook 3 can be seen in greater detail. The rod 2 and hook 3 have a steel interior 20 and plastic coating 21 on the exterior.

To remove a fishing hook from a fish, a user holds Honey Do Hook by the handle and inserts the hook into the fishing hook, usually located in the mouth of a fish. Then, the user pulls one direction with the handle and the opposite direction with the fishing line containing the fishing hook. The fish can then be flipped until the fish is free from the fishing hook.

The components of Honey Do Hook may vary widely but will likely utilize metal and plastic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Honey Do Hook can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

The size of Honey Do Hook may vary widely. The plastic used in making the fishing hook will ideally be made of an environmentally friendly material in case it is accidentally introduced into the marine environment.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A fishing device comprising:
(a) a handle;
(b) a rod connected to the handle; and
(c) a hook connected to the rod opposite the handle.

2. The device of claim 1 wherein the handle has an opening in the center and is shaped like an inverted triangle.

3. The device of claim 1 wherein the handle has an opening in the center and is shaped like an oval.

4. The device of claim 1 wherein the rod is approximately four inches in length.

5. The device of claim 1 wherein the hook is approximately three-quarters of an inch in width.

6. The device of claim 1 wherein the handle is approximately five inches in width.

7. The device of claim 1 wherein the handle, the rod and the hook have circular cross-sections that are one-eighth of an inch in diameter.

8. The device of claim 1 wherein the handle, the rod and the hook have a steel interior and a plastic coating on the exterior.

9. A fishing device comprising:
(a) a handle that is approximately five inches in width and is shaped like an inverted triangle with an opening in the center;
(b) a rod that is approximately four inches in length and connected to the handle;
(c) a hook that is approximately three-quarters of an inch thick and connected to the rod opposite the handle; and
(d) the handle, the rod and the hook are approximately one-eighth of an inch in diameter and have a steel interior and a plastic coating on the exterior.

10. A method for using a fishing device comprising the steps of:
(a) holding a handle;
(b) inserting a hook connected to the handle via a rod into a fishing hook attached to a fish; and
(c) pulling the handle in a first direction.

11. The method of claim 10 further comprising the step of
pulling a fishing line connected to the fishing hook in a second direction opposite the first direction.

12. The method of claim 11 further comprising the step of
flipping the fish until the fishing hook comes out of the fish.
